(19) United States
(12) Patent Application Publication
(10) Pub. No.: US 2009/0013685 A1
(43) Pub. Date: Jan. 15, 2009

(54) MASTER CYLINDER FOR VEHICLE BRAKE SYSTEM

(76) Inventor: Kelly J. Molenaar, Kalamazoo, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/110,568

(22) Filed: Apr. 28, 2008

Related U.S. Application Data
(60) Provisional application No. 60/949,126, filed on Jul. 11, 2007.

(51) Int. Cl. B60T 11/22

(52) U.S. Cl. 60/585

(57) ABSTRACT

A master cylinder for brake systems includes a housing defining a cavity. A plunger is movably disposed in the cavity, and includes an open end that receives a portion of a stationary member positioned within the housing. The plunger and stationary member control flow of brake fluid through the housing.

### CROSS REFERENCE TO RELATED APPLICATIONS

This application claims the benefit of U.S. Provisional Application No. 60/949,126, filed on Jul. 11, 2007, entitled MASTER CYLINDER FOR VEHICLE BRAKE SYSTEM, the entire contents of which are incorporated herein by reference.

### BACKGROUND OF THE INVENTION

Braking Systems for vehicles may include a master cylinder that provides pressurized brake fluid to actuate the brakes. One known type of brake master cylinder includes a reservoir and a master cylinder that is movably mounted inside a bore. When the master cylinder is retracted, brake fluid flows from the reservoir to the calipers or slave cylinders. As the master cylinder is actuated, the plunger within the bore shifts to pressurize the lines running to the calipers or slave cylinders, and also to prevent flow of fluid from the reservoir (or reservoirs).

### SUMMARY OF THE INVENTION

One aspect of the present invention is a brake system including a master cylinder having a housing defining an internal cavity. A movable member such as a plunger is at least partial disposed in the cavity. A stationary member extends into the cavity, and includes a fluid passageway that is fluidly connected to a reservoir. The plunger has an open inner end that, in use, receives a portion of the stationary member and defines a gap between the plunger and the stationary member. The plunger can be moved within the cavity to close the gap, such that flow of brake fluid through the gap is prevented. The plunger seals against an inner surface of the cavity, such that further movement of the plunger compresses brake fluid disposed in the cavity.

### BRIEF DESCRIPTION OF THE FIGURES

FIG. 1 is prospective view of a master cylinder and brake pedal assembly according to one aspect of the present invention;

FIG. 2 is a side elevational view of a brake master cylinder according to one aspect of the present invention;

FIG. 3 is a cross sectional view of a brake master cylinder according to one aspect of the present invention;

FIG. 4 is an isometric cross sectional view of a brake master cylinder according to one aspect of the present invention; and

FIG. 5 is an exploded isometric view of a brake master cylinder according to one aspect of the present invention.

### DETAILED DESCRIPTION OF PREFERRED EMBODIMENT

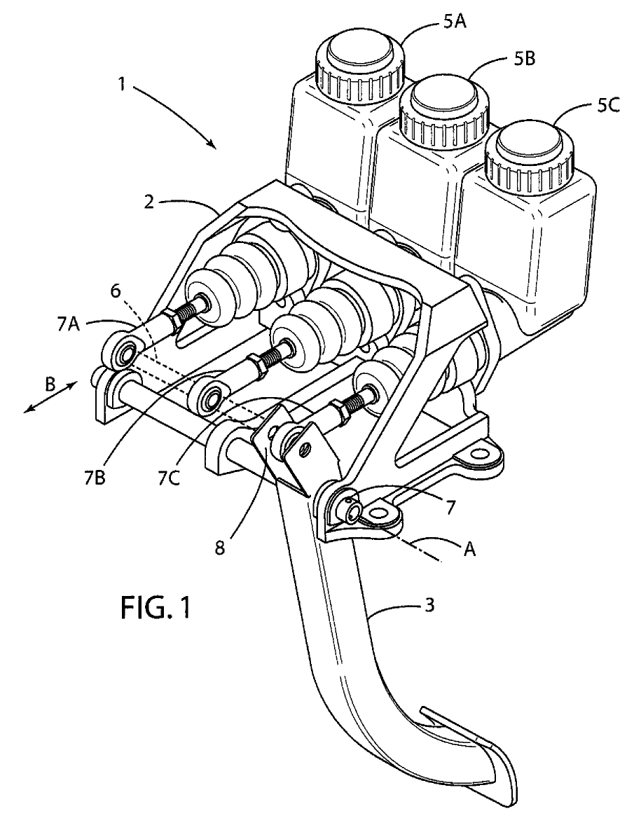

For purposes of description herein, the terms “upper,” “lower,” “right,” “left,” “rear,” “front,” “vertical,” “horizontal,” and derivatives thereof shall relate to the invention as oriented in FIG. 1.

With reference to FIG. 1, a brake system assembly 1, according to the present invention, may include a bracket 2 that pivotally supports a brake pedal 3, and provides for mounting of the assembly 1 in a motor vehicle or the like. In the illustrated example, the brake system assembly 1 includes three master cylinder assemblies 5A, 5B, and 5C. A rod 6 may be operatively connected to the push rods 7A, 7B, and 7C of the master cylinder assemblies 5A, 5B, and 5C, respectively to thereby operatively connect the push rods 7A, 7B, and 7C to an upper end 8 of brake pedal 3. Brake pedal 3 is pivotally mounted to the bracket to by a bearing 9, such that application of force to the brake pedal 3 causes the brake pedal 3 to pivot about an axis “A”, thereby shifting the push rods 7A, 7B, and 7C of master cylinder assemblies, 5A, 5B, and 5C, respectively, in the direction of the arrow “B”. Although three master cylinders assemblies 5A, 5B, and 5C are shown in FIG. 1, it will be understood that the present invention is not limited to a system including three master cylinder assemblies. A single master cylinder may be utilized depending upon the requirements of a particular application. Similarly, two, three or more master cylinders assemblies may also be utilized if required for a particular application.

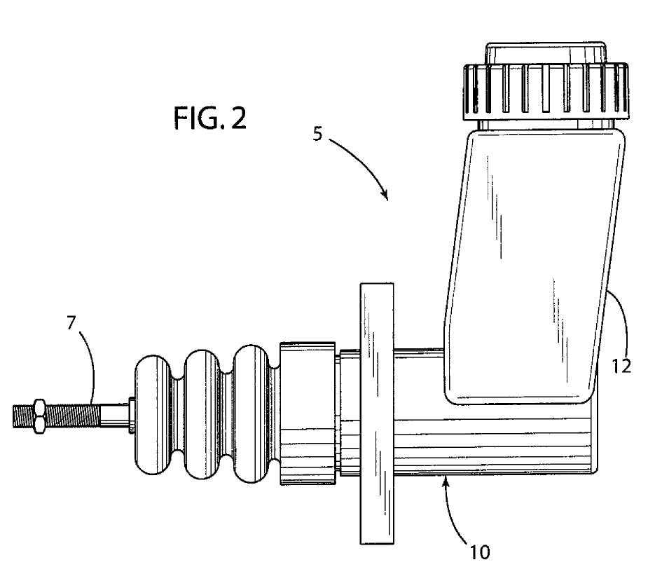

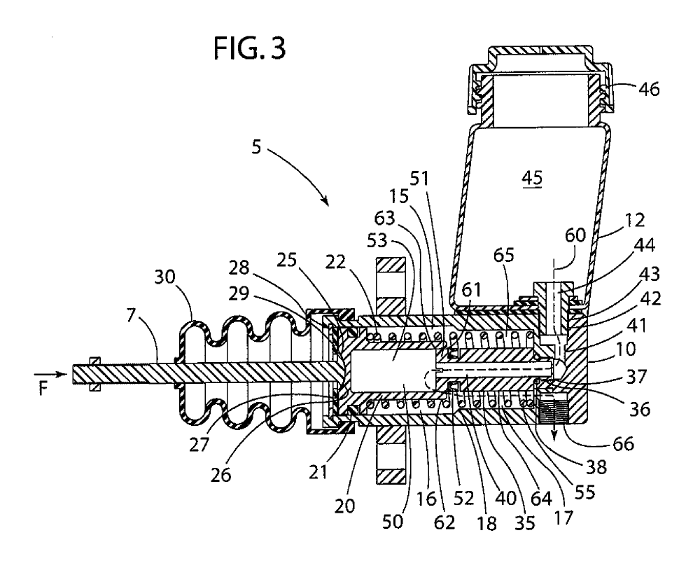

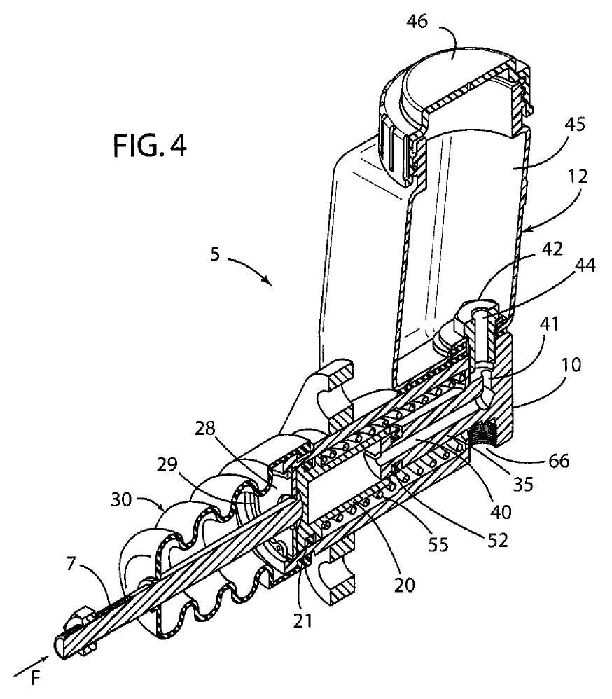

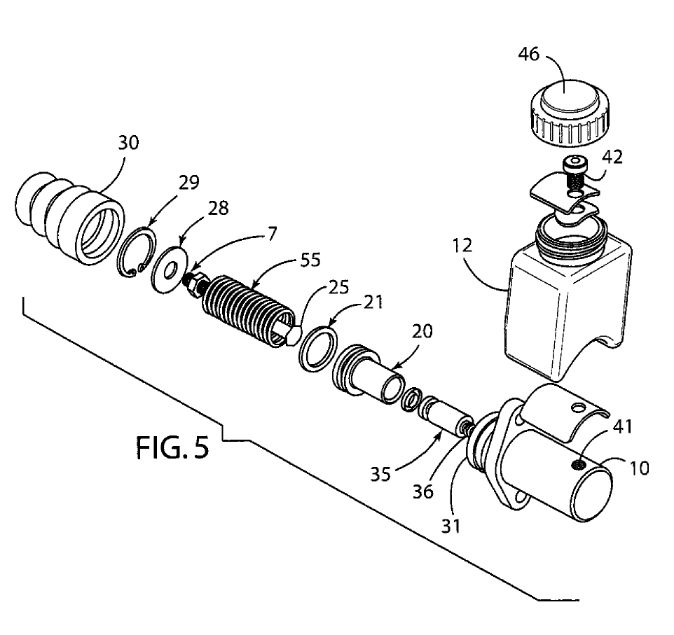

With further reference to FIG. 2, a master cylinder assembly 5 according to the present invention may include a housing 10, and a reservoir 12 mounted to the housing 10. With further reference to FIGS. 3-5, housing 10 includes an internal cavity 15 having a first portion 16 and a second portion 17. The first and second portion 16 and 17 are generally cylindrical, and the second portion 17 has a somewhat smaller diameter than first portion 16, thereby forming an annular step 18 at the transition from the first portion 16 to second portion 17. A plunger 20 is moveably mounted in the first portion 16 of internal cavity 15, and a first seal 21 mounted on plunger 20 engages the inner cylindrical surface 22 of first portion 16 of cavity 15. A first end 25 of pushrod 7 engages an indentation 26 in end surface 27 of plunger 20, and a washer 28 and retaining ring 29 interconnects the end 25 of pushrod 7 with plunger 20. A boot 30 is made on an elastomeric material, and encloses the end 31 of housing 10 to thereby insure that dirt or other foreign matter is not introduced into the internal cavity 15 or other components of the master cylinder assembly 5.

A stem 35 includes a threaded end 36 that engages a threaded opening 37 in housing 10, and an O-ring seal 38 provides a fluid-tight seal between stem 35 and housing 10. A bore or passageway 40 extends through the center of stem 35, and fluidly connects to a passageway 41 in housing 10. A fitting 42 threadably engages a threaded opening 43 in housing 10, and the fitting 42 includes an internal passageway 44 that fluidly connects the passageways 40 and 41 to an internal cavity 45 of reservoir 12. Reservoir 12 may include a cap 46 or the like that threadably engages the reservoir 12 to provide for the addition of brake fluid to the reservoir 12.

End portion 51 of stem 35 is configured to be received in a cylindrical cavity or bore 50 of plunger 20. As described in more detail below, in use a stem seal 52 sealingly engages the inner surface 53 of cylindrical cavity 50 when the stem 35 is received in cylindrical cavity 50. The inner surface 53 of cavity 50 of plunger 20 includes a tapered end surface 62 that provides a transition or guide surface that engages the stem seal 52 as the stem 35 is moved into the cavity 50 of plunger 20. Because the seal 52 protrudes outwardly beyond the outer surface 64 of stem 35, the end of plunger 20 would tend to damage the stem seal 52 if tapered surface 62 of plunger 20 were not present. In the illustrated example, the outer diameter of stem 35 is about 0.020 inches smaller than the inner diameter of the cylindrical cavity 50 of plunger 20. As described in more detail below, the tapered end surface 63 of plunger 20 also provides for a relatively gradual increase in the size of gap 61 formed between the outer surface 64 of stem 35 and the internal surfaces 53 and 63 of plunger 20.

A spring 55 biases the plunger 20 and push rod 7 away from the stem 35 to the position illustrated in FIG. 3. When the plunger 20 and push rod 7 are in the extended position of FIG. 3 (i.e. when no force is being applied to brake pedal 3 by a user), brake fluid from reservoir 12 can flow along the pathway 60. Specifically, the brake fluid can flow from the cavity 45 of reservoir 12 through the internal passageway 44 of fitting 43, through the passageway 41 of housing 10, through the passageway 40 of stem 35, and into the cylindrical cavity 50 of plunger 20. The brake fluid then flows back through annular gap 61 formed between the internal surface 53 and/or the tapered internal end surface 62 of plunger 20, and outer end surface 63 of stem 35. Due to the tapered surface 63 of plunger 20, the size of the gap 61 will vary as the end surface 63 of stem 35 is inserted or retracted from cylindrical cavity 50 of plunger 20. The tapered surface 63 provides for a relatively small change in the size of the gap 61 due to movement of plunger 20 relative to stem 35. The brake fluid then flows through the second portion 17 of internal cavity 15 between the outer surface 64 of stem 35 and cylindrical inner surface 65 of second portion 17 of internal cavity 15. The brake fluid can then exit through a threaded passageway/opening 66 in housing 10. In use one or more hydraulic or brake lines can be attached to the threaded passageway 66 to thereby fluidly connect the master cylinder 5 to the individual brake calipers, slave cylinders, or the like.

When a force is applied to the pushrod 7 in the direction of the arrow “F” (FIG. 3), the pushrod 7 and plunger 20 begin to move in a direction of the arrow “F”. As the stem 35 is inserted into the cylindrical cavity 50 of plunger 20, stem seal 52 engages the inner cylindrical surface 53 of cylindrical cavity 50 of plunger 20, thereby preventing flow of brake fluid out of cylindrical cavity 50 and into the second portion 17 of internal cavity 15. Because the plunger 20 is sealed against cylindrical inner surface 22 of first portion 16 of internal cavity 15, and brake fluid cannot flow from cavity 15 into passageway 40 of stem 35, further movement of plunger 20 in the direction of the arrow “F” causes the fluid within the internal cavity 15 to be pressurized. This causes pressurized brake fluid to be supplied to the threaded passageway/opening 66 and the calipers and/or slave cylinders (not shown) that are fluidly connected to the passageway 66. In this way, the master cylinder 5 provides for both refilling of the brake lines and pressurization of the brake fluid.

The master cylinder 5 provides a very compact, lightweight design that does not include internal seals that travel over openings in internal cylinders and the like in a manner that could otherwise lead to wear on to the seals.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A master cylinder for vehicle brake systems, comprising:
a housing having a first cavity defining a cylindrical sidewall surface, the first cavity defining an inner end and an outer end;
a stem disposed in the first cavity and extending from the inner end of the first cavity in a cantilevered manner and defining a distal end;
a plunger having at least a portion thereof moveably disposed in the first cavity and sealingly engaging the cylindrical sidewall of the cavity, the plunger having an inner end and an outer end and defining a second cavity, the second cavity having an open end at the inner end of the plunger, and wherein the stem is aligned with the open end of the second cavity;
a fluid reservoir configured to contain brake fluid;
a first fluid passageway extending from the reservoir through the stem and forming an opening at the distal end of the stem and fluidly connecting the reservoir to the second cavity;
a second fluid passageway fluidly connecting the first cavity to an outlet opening in the housing; and wherein:
the plunger is moveable relative to the stem between a first position wherein a gap is formed between the plunger and the stem, the gap fluidly interconnecting the first and second cavities, and a second position wherein the plunger sealingly engages the stem and substantially prevents fluid flow between the first and second cavities.

2. The master cylinder of claim 1, including:
a removable cover that permits brake fluid to be added to the reservoir.

3. The master cylinder of claim 1, wherein:
the gap formed between the plunger and the stem is substantially ring-shaped.

4. The master cylinder of claim 3, wherein:
the distal end of the stem includes a tapered end portion such that the area of the gap changes as the plunger moves relative to the stem.

5. The master cylinder of claim 4, including:
a resilient seal disposed about the stem adjacent the end thereof; and wherein:
the resilient seal forms a fluid-tight seal between the stem and a sidewall of the second cavity when the plunger is in the second position.

6. The master cylinder of claim 5, wherein:
the stem includes an outwardly-facing annular groove, and the resilient seal comprises an O-ring disposed in the annular groove.

7. The master cylinder of claim 1, wherein:
the second cavity defines an inner surface, and wherein a portion of the inner surface is cylindrical.

8. The master cylinder of claim 7, wherein:
the gap defines an area;
the portion comprises a first portion, and wherein the inner surface of the second cavity includes a tapered portion adjacent the open end of the second cavity whereby the area of the gap changes as the plunger moves relative to the stem.

9. The master cylinder of claim 1, wherein:
the plunger is biased away from the stem.

10. The master cylinder of claim 9, including:
a spring biasing the plunger away from the stem.

11. The master cylinder of claim 1, wherein:
the cylindrical sidewall of the cavity includes a first portion defining a first diameter, and a second portion defining a second diameter that is greater than the first diameter, and wherein the plunger sealingly engages the second portion of the cylindrical sidewall.

12. The master cylinder of claim 11, wherein:
the plunger includes an annular groove adjacent the outer end of the plunger; and including:
a resilient O-ring disposed in the annular groove and engaging the second portion of the cylindrical sidewall.

13. The master cylinder of claim 1, wherein:
the outer end of the plunger defines an outer side face having an outwardly-facing indentation; and including:
a rod having an end engaging the indentation.

14. A master cylinder for vehicle brake systems, comprising:
a housing having a first cavity;
a stem disposed in the first cavity, the stem defining a distal end;
a plunger having at least a portion thereof moveably disposed in the first cavity, the plunger having a second cavity, the second cavity having an open end aligned with the stem;
a first fluid passageway having an opening at the distal end of the stem;
a second fluid passageway fluidly connecting the first cavity to an outlet opening in the housing; and wherein:
the plunger is moveable relative to the stem between a first position wherein a gap is formed between the plunger and the stem, the gap fluidly interconnecting the first and second cavities, and a second position wherein the plunger sealingly engages the stem and substantially prevents fluid flow between the first and second cavities.

15. The master cylinder of claim 14, including:
a fluid reservoir fluidly connected to the first passageway.

16. The master cylinder of claim 14, wherein:
the first cavity defines a cylindrical sidewall surface, and the plunger sealingly engages the cylindrical sidewall surface.

17. The master cylinder of claim 14, wherein:
the first cavity defines an inner end and an outer end;
the second fluid passageway defines an opening to the first cavity, and wherein the opening is located adjacent the inner end of the first cavity.

18. The master cylinder of claim 14, wherein:
the stem threadably engages the housing, and the first passageway forms an inlet opening in the housing and extends from the inlet opening to the distal end of the stem.

19. The master cylinder of claim 18, including:
a fluid reservoir fluidly connected to the inlet opening.

20. The master cylinder of claim 14, wherein:
the gap defines an area, and a magnitude of the area changes as the plunger moves relative to the stem.
